(19) United States
(12) Patent Application Publication
(10) Pub. No.: US 2023/0143728 A1
(43) Pub. Date: May 11, 2023

(54) HOLOGRAPHIC DISPLAY SYSTEM AND METHOD

(71) Applicant: VividQ Limited, London (GB)

(72) Inventors: Alfred James NEWMAN, London (GB); Thomas James DURRANT, London (GB); Andrzej KACZOROWSKI, London (GB); Darran Francis MILNE, London (GB)

(21) Appl. No.: 18/093,190

(22) Filed: Jan. 4, 2023

Related U.S. Application Data
(63) Continuation of application No. PCT/GB2021/051696, filed on Jul. 5, 2021.

(30) Foreign Application Priority Data
Jul. 6, 2020 (GB) 2010354.5
Dec. 18, 2020 (GB) 2020121.6

(51) Int. Cl. G03H 1/22

(52) U.S. Cl. CPC G03H 1/2202; G03H 1/2294; G03H 2223/19; G03H 2225/34; G03H 2226/05; G03H 2222/20; G03H 2001/2242

(57) ABSTRACT

A holographic display comprises: an illumination source which is at least partially coherent; a plurality of display elements positioned to receive light from the illumination source and spaced apart from each other, each display element comprising a group of at least two sub-elements; and a modulation system associated with each display element and configured to modulate at least a phase of each of the plurality of sub-elements.

### CROSS-REFERENCE TO RELATED APPLICATIONS

This application is a continuation under 35 U.S.C. § 120 International Application No. PCT/GB2021/051696, filed Jul. 5, 2021, which claims priority to GB Application No. GB2010354.5, filed Jul. 6, 2020, and GB Application No. GB2020121.6, filed Dec. 18, 2020, under 35 U.S.C. § 119(a). Each of the above-referenced patent applications is incorporated by reference in its entirety.

### BACKGROUND

### Technical Field

The present invention relates to a holographic display system and a method of operating a holographic display system.

### Background

Computer-Generated Holograms (CGH) are known. Unlike an image displayed on a conventional display which is modulated only for amplitude, CGH displays modulate phase and result in an image which preserves depth information from a viewing position.

CGH displays have been proposed which produce an image plane of sufficient size for a viewer's pupil. In such displays, the hologram calculated is a complex electric field somewhere in the region of the viewer's pupil. Most of the information at that position is in the phase variation, so the display can use a phase-only Spatial Light Modulator (SLM) by re-imaging the SLM onto the pupil. Such displays require careful positioning relative to the eye to ensure that an image plane generally coincides with the pupil plane. For example, a CGH display may be mounted in a headset or visor to position the image plane in the correct place relative to a user's eye. Expanding CGH displays to cover both eyes of a user has so far focused on binocular displays which contain two SLMs or displays, one for each eye.

While binocular displays allow true stereoscopic CGH images to be experienced, it would be desirable for a single holographic display to display an image which appears different when viewed from different positions.

### SUMMARY

According to a first aspect of the present invention, there is provided a holographic display that comprises: an illumination source which is at least partially coherent; a plurality of display elements and a modulation system. The plurality of display elements are positioned to receive light from the illumination source and spaced apart from each other, with each display element comprising a group of at least two sub-elements. The modulation system is associated with each display element and configured to modulate at least a phase of each of the plurality of sub-elements.

By modulating the phase of the sub-elements making up each display element the sub-elements can be combined into an emitter which appears as a point emitter having different amplitude and phase when viewed from different positions. In this way, the location of the different positions for viewing can be controlled as desired. For example, the positions for viewing can be predetermined or determined based on input, such as input from an eye position tracking system. The viewing positions can therefore be moved or adjusted by the modulation, using software or firmware. Some examples may combine this software-based adjustment of viewing position with a physical or hardware-based adjustment of viewing position. Other examples may have no physical or hardware-based adjustment. A binocular holographic image can therefore be generated from a single holographic display, allowing CGH to be applied to larger area displays, such as those having a diagonal measurement of at least 10 cm. The technique can also be applied to smaller area displays, for example it could simplify binocular CGH headset construction. In a binocular CGH display it could allow adjustments for Interpupillary Distance (IPD) to be carried out at the control system level rather than mechanically or optically.

Such a holographic display has the effect of creating a sparse image field, allowing a greater field of view without unduly increasing the number of sub-elements required. Such a sparse image field may comprise spaced apart groups of sub-elements, with sub-elements occupying less than 25%, less than 20%, less than 10%, less than 5%, less than 2% or less than 1% of the image area.

Various different modulation systems can be used, including a transparent Liquid Crystal Display (LCD) system or an SLM. LCD systems allow a linear optical path and can be adapted to control phase as well as amplitude.

A partially coherent illumination source preferably has sufficient coherence that the light from respective sub-elements within each display element can interfere with each other. A partially coherent illumination source includes illumination sources which are substantially wholly coherent, such as laser-based illumination sources, and illumination sources which include some incoherent components but are still sufficiently coherent for interference patterns to be generated, such as super luminescent diodes. The illumination source may comprise a single light emitter or a plurality of light emitters and has an illumination area sufficient to illuminate the plurality display elements. A suitably sized illumination area may be formed by enlarging the light emitter(s) such as by (i) pupil replication using a waveguide/Holographic Optical Element, (ii) a wedge, or (iii) localised emitters, such as localised diodes. Some specific examples that can be used to provide a suitably sized illumination area include:
a pupil-replicating holographic optical element (HOE) used in holographic waveguides, such as described in “Holographic waveguide heads-up display for longitudinal image magnification and pupil expansion”, Colton M. Bigler, Pierre-Alexandre Blanche, and Kalluri Sarma, Applied Optics, Vol. 57, No. 9, 20 Mar. 2018, pp 2007-2013.
a wedge-shaped waveguide using total-internal reflection to keep light inside the waveguide, such as described in “Collimated light from a waveguide for a display backlight”, Adrian Travis, Tim Large, Neil Emerton and Steven Bathiche, Optics Express, Vol 17, No 22, 15 Oct. 2009, pp 19714-19719;
multiple laser diodes or super luminescent diodes collimated by an optical system, such as a collimating microlens array.

Some examples include an optical system configured to generate the plurality of display elements by reducing the size of the group of sub-elements within each display element such that the group of sub-elements are spaced closer to each other than they are to sub-elements of an immediately adjacent display element. The optical system may be configured to generate the plurality of display elements by reducing a size of the sub-elements within a display element but not reducing a spacing between a centre of adjacent display elements. This can allow an array with all the sub-elements separated by substantially equal spacing (such as might be manufactured for an LCD) to be re-imaged to form the display elements. Following such a re-imaging, sub-elements within a display element are spaced closer to each other than they are to sub-elements of an immediately adjacent display element. Any suitable optical system can be used, examples include a plurality of microlenses, a diffraction grating, or a pin hole mask. In some examples, the optical system reduces the size of the sub-elements by at least 2 times, at least 5 times, or at least 10 times.

The optical system may comprise an array of optical elements. In one example, the array of optical elements have a spacing which is the same as the spacing of the display elements, each optical element producing a reduced size image of an underlying array of display sub-elements.

In some examples, the modulation system is configured to modulate an amplitude of each of the plurality of sub-elements. This allows a further degree of freedom for controlling each sub-element. A single integrated modulation system may control both phase and amplitude, or separate phase and modulation elements may be provided, such as stacked transparent LCD modulators for amplitude and phase. The amplitude and phase modulation may be provided in any order (i.e. amplitude first or phase first in the optical path).

Each display element may consist of a two-dimensional group of sub-elements having dimensions n by m, where n and m are integers, n is greater than or equal to 2 and m is greater than or equal to 1. Such a rectangular or square array can be controlled so that the output of each sub-element combines to give different amplitude and phase at each viewing position. In general, two degrees of freedom (an amplitude or phase variable) are required for each viewing position possible for the display.

Two viewing positions are required for a binocular display (one for each eye). A binocular display may thus be formed when n is equal to 2, m is equal to 1 and the modulation system is configured to modulate a phase and an amplitude of each sub-element (giving four degrees of freedom). Alternatively, a binocular display can be formed when n is equal to 2, m is equal to 2 and the modulation system is configured to modulate a phase of each sub-element. This again has four degrees of freedom and may be simpler to construct because amplitude modulation is not required. Increasing the degrees of freedom beyond four by including more sub-elements within each display element can allow further use cases, for example supporting two or more viewers from a single display

The holographic display may comprise a convergence system arranged to direct an output of the holographic display towards a viewing position. This is useful when the size of display is greater than a size of a viewing plane, to direct the light output from the display element towards the viewing plane. For example, the convergence system could be a Fresnel lens or individual elements associated with each display element.

A mask configured to limit a size of the sub-elements may also be included. This may reduce the size of the sub-elements and increase an addressable viewing area.

According to a second aspect of the present invention there is provided an apparatus comprising a holographic display as discussed above and a controller. The controller is for controlling the modulation system such that each display element has a first amplitude and phase when viewed from a first position and a second amplitude and phase when viewed from a second position. The controller may be supplied the relevant parameters for control from another device, so that the controller drives the modulation element but does not itself calculate the required output for the desired image field to be represented by the display. Alternatively, or additionally, the controller may receive an image for data for display and calculate the required modulation parameters.

Some examples may comprise an eye-locating system configured to determine the first position and the second position. This can allow minimal user interaction to view a binocular holographic image and reduce a need for the display to be at a predetermined position relative to the user. The eye locating system may provide a coordinate of an eye corresponding to the first and second positions relative to a known position, such as a camera at a predetermined position relative to the screen

In other examples, the apparatus may assume a predetermined position of a viewer as the first and second position. For example, the apparatus may generally be at a fixed position in front of a viewer, or a viewer may be directed to stand in a particular position. In another example, a viewer may provide input to adjust the first and second position.

According to a third aspect of the invention there is provided a method of displaying a computer-generated hologram. The method comprises controlling a phase of a plurality of groups of sub-elements such that the output of sub-elements within each group combines to produce a respective first amplitude and first phase at a first viewing position and a respective second amplitude and second phase at a second viewing position. In this way each group of sub-elements can be perceived in a different way at different positions, enabling binocular viewing from a single display. While the first and second amplitude and phase are generally different they may be substantially the same in some cases, for example when representing a point far away from the viewing position.

As discussed above for the first aspect, two degrees of freedom in the group of sub-elements are required for each viewing position. If only phase is controlled, at least four sub-elements are required for binocular viewing. In some examples, the controlling further comprises controlling an amplitude of the plurality of groups of sub-elements. This can allow a further degree of freedom, enabling two viewing positions from two sub-elements controlled for both amplitude and phase.

The first and second position may be predetermined or otherwise received from an input into the system. In some examples, the method may comprise determining the first viewing position and the second viewing position based on input received from an eye-locating system.

According to a fourth aspect of the invention there is provided an optical system for a holographic display. As described above, the optical system is configured to generate a plurality of display elements by reducing a size of a group of sub-elements within each display element such that the group of sub-elements are spaced/arranged/positioned closer to each other than they are to sub-elements of an immediately adjacent display element. In this particular aspect, the optical system is configured such that it has different magnifications in first and second dimensions (such as along a first axis and a second axis respectively), where a first magnification in the first dimension is less/lower than a second magnification in second dimension.

Such an optical system allows the magnification in the second dimension to be increased relative to the first dimension, thereby increasing the range of positions along the second dimension that the display can be viewed from. In a particular example, the first dimension is a horizontal dimension and the second dimension is a vertical dimension. This effectively increases the addressable viewing area along the second dimension.

With the magnification being increased in the vertical dimension, the range of vertical viewing positions can be increased, which means an observer/viewer can view the display over an increased vertical range. In contrast, the magnification in the first dimension is generally constrained by the angle subtended between the pupils of an observer, so is constrained by the inter-pupillary distance (IPD), and so remains fixed by a typical angle subtended by the viewer's eyes. This is particularly useful where the holographic display is used in a single orientation.

Accordingly, in a particular example, the first dimension is substantially horizontal in use. The first dimension may be defined by a first axis and the first axis is generally arranged so that it is parallel to an axis extending between the pupils of an observer. The second dimension may be perpendicular to the first dimension, and may be vertical or substantially vertical dimension. The second dimension may be defined by a second axis. A third dimension or third axis is perpendicular to both the first and second dimensions/axes. The third dimension/axis may be parallel to a pupillary axis of a pupil of the observer. The first axis may be an x-axis, the second axis may be a y-axis and the third axis may be a z-axis, for example.

In some examples, the optical system comprises an array of optical elements, and each optical element comprises first and second lens surfaces, and at least one of the first and second lens surfaces has a different radius of curvature in a first plane (defined by the first dimension and a third dimension) than in a second plane (defined in the second dimension and the third dimension). Expressed differently, the first surface may be defined by an arc of a first radius of curvature in the first plane which is then rotated around a first axis (of the first dimension) with a second radius of curvature in the second plane (the first and second radii being different). The surface could also be described by having deformation in the third dimension (along the third axis) and be described by ax²+by², where a is not equal to b.

The first and second lens surfaces are spaced apart along an optical axis of the optical element. The first lens surface is configured to receive light from the illumination source as it enters the optical element.

Controlling the curvatures of the lens surfaces allows the focal length of that particular lens surface to be controlled, which in turn controls the magnification of the optical element. By setting specific curvatures, the magnifications can be configured so that the second magnification is greater than the first magnification. In a particular example, each lens surface has a radius of curvature in the first plane and a different radius of curvature in the second plane.

An example lens surface having different curvatures in different planes is a toric lens. Accordingly, at least one of the first and second lens surfaces is a toric lens surface.

Altering the curvature of a lens in one plane can also alter the focal length of the lens in that plane. Accordingly, if a lens surface has to different curvatures in two different planes, the lens surface is associated with two different focal lengths, where a focal length is associated with each plane. Accordingly, in an example, the first and second lens surfaces are associated with first and second focal lengths respectively in a first plane (defined by the first dimension and a third dimension), and the first magnification is defined by the ratio of first and second focal lengths. Similarly, the first and second lens surfaces are associated with third and fourth focal lengths respectively in a second plane (defined by the second dimension and the third dimension), and the second magnification is defined by the ratio of third and fourth focal lengths.

Thus, more specifically, the magnifications can be controlled by controlling the ratio of the first and second focal lengths and the ratio of the third and fourth focal lengths.

In a particular example, the second magnification in the second dimension is at least 15. In another example, the second magnification in the second dimension is greater than 2. In one example, the second magnification in the second dimension is less than about 30, such as greater than about 2 and less than about 30 or greater than about 15 and less than about 30. In one example, the first magnification in the first dimension is between about 2 and about 15. In another example, the second magnification in the second dimension is less than about 30, such as greater than about 3 and less than about 30. In another example, the first magnification in the first dimension is between about 3 and about 15.

According to a fifth aspect of the present invention there is provided a holographic display comprising an optical system according to the fourth aspect.

According to a sixth aspect of the present invention there is provided a computing device comprising a holographic display system according to the fifth aspect. In use, a horizontal axis of the holographic display is arranged substantially parallel to the first dimension. Accordingly, in such a computing device, the display is typically viewed in one orientation and a viewer's eyes are approximately aligned with the horizontal axis of the display.

According to a seventh aspect of the present invention there is provided an optical system for a holographic display, the optical system being configured to generate a plurality of display elements by reducing a size of a group of sub-elements within each display element such that the group of sub-elements are positioned closer to each other than they are to sub-elements of an immediately adjacent display element. The optical system comprises an array of optical elements each comprising: (i) a first lens surface configured to receive light having a first wavelength and light having a second wavelength, different from the first wavelength, and (ii) a second lens surface in an optical path with the first lens surface. The first lens surface comprises a first surface portion optically adapted for the first wavelength and a second surface portion optically adapted for the second wavelength. The first and second lens surfaces may be spaced apart along an optical axis of the optical element. For example, light is incident upon the first lens surface, travels through the optical element before passing through the second lens surface and towards the observer. In an example, there may be a separate emitter emitting light of each wavelength. In another example, there is a single emitter emitting a plurality of wavelengths which then pass through a filter configured to pass light of a particular wavelength.

Such a system at least partially compensates for the wavelength dependent behaviour of light as it passes through the optical elements. By providing different surface portions, where each surface portion is adapted for a specific wavelength of light, the light of different wavelengths can be controlled more precisely so that it can be focused towards substantially the same point in space (close to the observer). This is particularly useful when the emitters are positioned relative to the first lens surface so that light from each emitter is generally incident upon a particular portion of the first lens surface. This wavelength dependent control improves the image quality when sub-elements have different colours (wavelengths).

The first surface portion may not be optically adapted for the second wavelength and the second surface portion may not be optically adapted for the first wavelength. The first surface may be discontinuous, and so comprises a stepped profile between the first and second surface portions.

In one example, the first surface portion is optically adapted for the first wavelength by having a first radius of curvature and the second surface portion is optically adapted for the second wavelength by having a second radius of curvature. As discussed above, the surface curvature controls the focal length of the optical element, thereby allowing the location of the focal point for each wavelength to be controlled. The focal points for the different wavelengths may be coincident or spaced apart, depending upon the desired effect.

In some examples, the first lens surface has a first focal point for light having the first wavelength and the second lens surface has a second focal point for light having the first wavelength and the first and second focal points are coincident. Similarly, the first lens surface has a third focal point for light having the second wavelength and the second lens surface has a fourth focal point for light having the second wavelength and the third and fourth focal points are coincident. By overlapping in space the first and second focal points (and the third and fourth focal points) the image quality can be improved.

In one example, the first lens surface of each optical element is further configured to receive light having a third wavelength, different from the first and second wavelengths. The first lens surface further comprises a third surface portion optically adapted for the third wavelength. The first wavelength may correspond to red light, the second wavelength may correspond to green light and the third wavelength may correspond to blue light, for example. Thus, a full colour holographic display can be provided. In an example, the first wavelength is between about 625 nm and about 700 nm, the second wavelength is between about 500 nm and about 565 nm and the third wavelength is between about 450 nm and about 485 nm.

According to an eighth aspect of the present invention there is provided an optical system for a holographic display, the optical system being configured to: (i) generate a plurality of display elements by reducing a size of the group of sub-elements within each display element such that the group of sub-elements are positioned closer to each other than they are to sub-elements of an immediately adjacent display element, and (ii) converge light passing through the optical system towards a viewing position.

Such a system allows a display (that is large compared to the viewing area) to direct light from the edges of the display towards the viewing area. In this system this convergence is achieved by the optical system, so no additional components are needed.

In a particular example, the optical system comprises an array of optical elements, each optical element comprising a first lens surface with a first optical axis and a second lens surface with a second optical axis and wherein the first optical axis is offset from the second optical axis. It has been found that this offset in optical axes between the first and second lens surfaces causes light to converge towards the viewing area. The second optical axis may be offset in a direction towards the center of the array, for example. In a specific example, an optical element positioned closer to an edge of the display has an offset (between its first and second optical axes) that is greater than an offset for an optical element positioned closer to a center of the display. This greater offset bends the light to a greater extent (i.e. the light rays from each individual optical element are still emitted collimated, but light rays from the optical elements are directed towards a viewing position by being bent away from the optical axis to a greater extent for an optical element closer to an edge of the display), which is desirable given that the optical element is further away from the center of the display. The offset is measured in a dimension across the array (i.e. parallel to one of the first and second axes). In some examples, the offset is only present in one dimension across the array (such as along the first axis). This may be useful if the array is rectangular in shape, so the offset may only be present along the longest dimension of the display (such as along the first axis for rectangular display arranged in landscape).

In an example, the offset may be between about 0 μm and about 100 μm, such as between about 1 μm and about 100 μm.

In an example, the second lens surfaces are arranged to face towards a viewer and the first lens surfaces are arranged to face an illumination source, in use.

In another example, the optical system comprises an array of optical elements, wherein each optical element comprises a first lens surface and a second lens surface spaced apart from the first lens surface along an optical path through the optical element, and wherein the first lens surfaces are distributed across the array at a first pitch and the second lens surfaces are distributed across the array at a second pitch, the second pitch being smaller than the first pitch. Again, this difference in pitch means that the system can direct light from the edges of the display towards the viewing area. The first pitch is defined as a distance between the centers of adjacent first lens surfaces. The second pitch is defined as a distance between the centers of adjacent second lens surfaces. The center of a lens surface may correspond to the position of an optical axis of the lens surface.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagrammatic representation of a CGH image positioned away from a pupil plane of a viewer's eye.

FIG. 2 is a diagrammatic representation of the principle of reimaging groups of sub-elements to form display elements used in some examples.

FIG. 3 is a diagrammatic representation of an example holographic display.

FIG. 4 is a diagrammatic representation of another example holographic display.

FIG. 5 is a schematic diagram of an apparatus including the display of FIG. 3 or 4.

FIG. 6 depicts example geometry of a 2×1 display element for use with the display of FIGS. 3 and 4.

FIG. 7 is a diagrammatic representation of possible viewing positions for a display using the display element of FIG. 6.

FIGS. 8, 9 and 10 are diagrammatic representations of how a display element can be controlled to produce different amplitude and phase at different viewing positions.

FIG. 11 is an example control method that can be used with the display of FIG. 3 or 4.

FIG. 12 is a diagrammatic representation of an optical system according to an example.

FIG. 13 is a cross section of an optical element in a first plane to show surface curvature.

FIG. 14 is a cross section of an optical element in a second plane to show surface curvature.

FIG. 15 is a cross section of an array of optical elements in a first plane to show the convergence of light towards an area.

FIG. 16 is a cross section of an optical element in a first plane to show an offset of an optical axis.

FIG. 17 is a cross section of an optical element in a first plane to show surface portions adapted for particular wavelengths of light.

### DETAILED DESCRIPTION

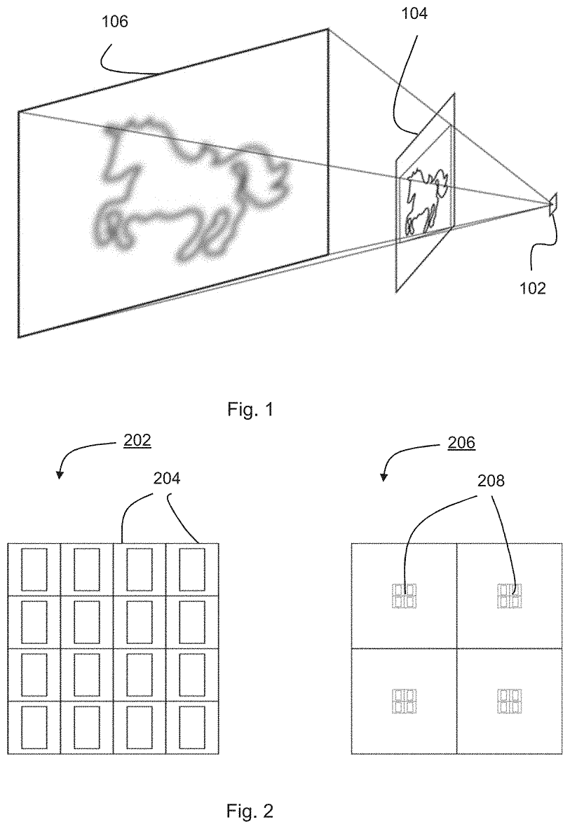

SLM-based displays are normally used to calculate a complex electric field somewhere in the region of a viewer's pupil. However, the complex electrical field can be calculated for any plane, such as in a screen plane. Away from the pupil plane, most of the image information is in amplitude rather than phase, but control of phase is still required to keep defocus. This is shown diagrammatically in FIG. 1. A pupil plane 102 contains mostly phase information. A virtual image plane 104 contains mostly amplitude information, but may also have phase information, for example to encode a scatter profile across the image. A screen plane 106 contains mostly amplitude information, with phase encoding focus. While a single virtual image plane 104 is shown in FIG. 1 for clarity, additional depth layers can be included.

Assuming that the field at each plane is sampled on a grid of points, each of those points can be considered as a point source with a given phase and amplitude. Taking the pupil plane 102 as the limiting aperture, the total number of points needed to describe the field is independent of the location of the plane. For a square pupil plane of width w, a field of view of horizontal angle θₓ and vertical angle θ_{y} can be displayed by sampling with a grid of points having approximate dimensions of wθₓ/λ by wθ_{y}/λ.

If the viewer's eye position is known, for example by tracking the position of a user's eye or positioning the screen at a known position relative to the eye, a CGH can be calculated which displays correctly at the pupil plane providing that sufficient point sources are available to generate the image. Eye-tracking could be managed in any suitable way, for example by using a camera system, such as might be used for biometric face recognition, to track a position of a user's eye. The camera system could, for example, use structured light, multiple cameras, or time of flight measurement to return depth information and locate a viewer's eye in 3D space and hence determine the location of the pupil plane.

In this way, a binocular display could be made by ensuring that the pupil plane is sufficiently large to include both a viewer's pupils. Rather than the two displays of a binocular headset, a single display can be used for binocular viewing, with each eye perceiving a different image. Manufacturing such a binocular display is challenging because, for a typical field of view, the number of point emitters required to give a pupil plane large enough to include both of a viewer's eyes is extremely large (of the order of billions of point sources).

CGH displays can display information by time division multiplexing Red, Green and Blue components and using persistence of vision so that these are perceived as a combined colour image by a viewer. From the discussion above, the number points required for a given size of the pupil plane in such a system will vary for each of the red, green and blue images because of the different wavelengths (the presence of λ in the equations wθₓ/λ by wθ_{y}/λ). It is useful to have the same number of points for each colour. In that case, setting the green wavelength to the desired pupil plane size sets the mid-point, with the red and blue image planes then being slightly larger and slightly smaller than the green image plane, respectively.

For a single eye display, a pupil plane might be 10 mm by 10 mm, so that there is some room for movement of the eye within that plane. This could allow for some inaccuracy in the positioning of the eye. A typical green wavelength used in displays is 520 nm and a field of view might be 0.48 by 0.3 radians, which is similar to viewing a 16:10, 33 cm (13 inch) display at a distance of 60 cm. The resulting grid would then be (10 mm×0.48)/520 nm=9,230 points wide by (10 mm×0.3)/520 nm=5769 points high. The total number of point emitters required is therefore around 53 million. Scaling to larger displays having a pupil plane sufficient to cover both eyes requires a significantly larger number of point emitters: a pupil plane of 50 mm×100 mm would require around 2.7 billion point emitters. While the number of point emitters can be reduced by limiting the field of view, the resulting hologram viewed then becomes very small.

It would be useful to be able to be able to display a binocular hologram with a smaller number of point emitters.

As will be described in more detail below, embodiments control display elements that comprise groups of sub-elements within a display so that the display element is perceived as a point source with different amplitude and phase from different viewing positions. The groups of sub-elements are small within the image plane of the display element with a larger spacing between display elements. The result is a sparsely populated image plane with point sources spaced apart from each other by the overall spacing between the display elements. Providing that each display element has at least four degrees of freedom (the number of phase and/or amplitude variables that can be controlled) then a single display can, in effect, be driven to create two smaller pupil planes directed towards the eyes of a viewer. As the group of sub-elements and/or the degrees of freedom increase, it also becomes possible to support multiple viewers of the same display. For example, an eight degree of freedom display could produce four directed image planes and thus support two viewers (four eyes).

One way to produce display elements used in examples is to reimage an array of substantially equally spaced sub-elements to form the display elements. The reimaging of groups of sub-elements to a smaller size is shown diagrammatically in FIG. 2. On the left, array 202 comprises multiple sub-elements 204 which can be controlled to modulate a light field. If array 202 was controlled without reimaging, it would correspond to screen 106 of FIG. 1, so that it might comprise 53 million picture elements 204 for an image plane of 10 mm by 10 mm. In examples, the array 202 is reimaged so that display elements comprising groups of sub-elements are formed. As shown in FIG. 2, each display element consists of a 2×2 square with the sub-elements reduced in size to occupy a smaller part of the area of the display element, but the spacing between groups is maintained.

Array 202 is reimaged as array 206 of display elements comprising groups 208 of sub-elements of reduced size but at the same spacing between the centres of the groups as in the original array 202. Put another way, in the re-imaged array 206 comprises sparse clusters of pixels where the pitch between clusters is wider than the original pitch, but the pitch between re-imaged pixels in a cluster is smaller than the original pitch. Through this reimaging, it is possible to obtain the benefits of a wider effective field of view without increasing the overall pixel count because individual sub-elements within the display element can be controlled to appear as a point emitter with different amplitude and phase when viewed from different positions.

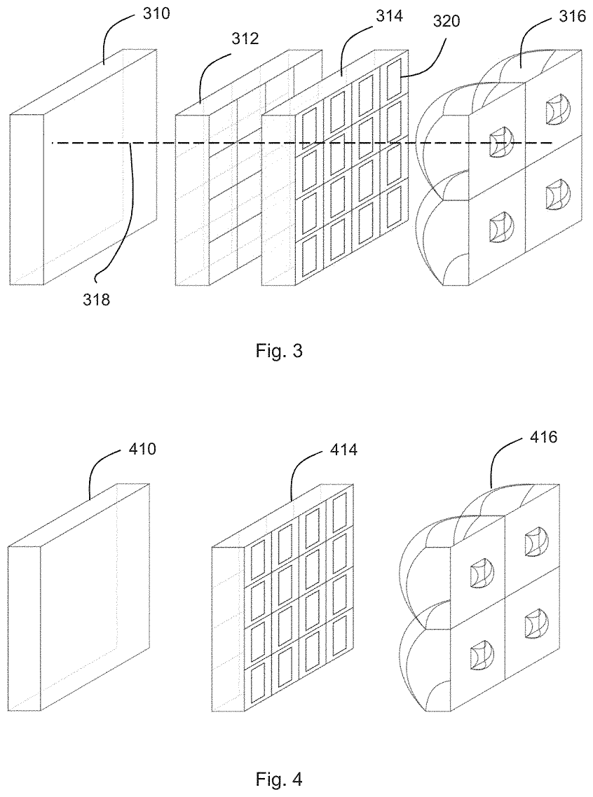

Example constructions of a display in which groups of pixels are reimaged as sparsely populated point sources within a wider image field will now be described. FIG. 3 is a diagrammatic exploded view of a holographic display which comprises a coherent illumination source 310, an amplitude modulating element 312, a phase modulating element 314 and an optical system 316.

The coherent illumination source 310 can have any suitable form. In this example it is a pupil-replicating holographic optical element (HOE) used in holographic waveguides. The coherent illumination source 310 is controlled to emit Red, Green or Blue light using time division multiplexing. Other examples may use other backlights to provide at least partially coherent light.

The example of FIG. 3 has a single coherent light emitter used as part of the illumination source and covering the entire area, alternative constructions could provide a plurality of coherent light emitters which together illuminate the image area. For example, multiple lasers may be injected at respective positions to provide sufficient illumination area. Examples using a plurality of light emitters may also have the ability to control coherent light emitters individually or by region, enabling reduced power consumption and/or increased contrast.

Amplitude-modulating element 312 and phase-modulating element 314 are both Liquid Crystal Display (LCD) layers which are stacked and aligned so that their constituent elements are in a same optical direction. Each consists of a backplane with transparent electrodes matching the underlying pixel pattern, a ground plane, and one or more waveplate/polarising films. Amplitude-modulating LCDs are well known, and a phase modulating LCD can be manufactured by altering the polarisation elements. One example of how to manufacture a phase modulating LCD is discussed in the paper “Phase-only modulation with a twisted nematic liquid crystal display by means of equi-azimuth polarization states”, V. Duran, J. Lancis, E. Tajahuerce and M. Fernandez-Alonso, Optics Express, Vol. 14, No. 12, pp 5607-5616, 12 Jun. 2006.

Optical system 316 is a microlens layer in this embodiment. Microlens arrays can be manufactured by a lithographic process to create a stamp and are known for other purposes, such as to provide a greater effective fill-factor on digital image sensors. Here the microlens array comprises a pair of positive lenses for each group of sub-elements to be re-imaged. The focal length of these lenses is f₁ and f₂, respectively, producing a reduction in size by a factor of f₁/f₂. The reduction in size is 10× in this example, other reduction factors can be used in other examples. To provide the required spacing between display elements, each microlens has an optical axis passing through a geometrical centre of the group of sub-elements. One such optical axis 318 is depicted as a dashed line in FIG. 3.

Other examples may use alternative optical systems than a microlens array. This could include diffraction gratings to achieve the desired focusing or a blocking mask, such as a blocking mask with a small diameter aperture positioned at each corner of a display element. A blocking mask may be easier to manufacture than a microlens array, but a blocking mask will have lower efficiency because much of the coherent illumination source is blocked.

Also visible in FIG. 3 is a mask 320 on the surface of phase modulating element 314. This reduces the size of each sub-element and increases the addressable viewing area. This is because the angle of the emission cone from each sub-element is inversely proportional to the emitting width of the sub-element. In other examples, the mask may be omitted or provided at another position. Other positions for the mask include between the coherent illumination source and the amplitude-modulating element 312, and on the amplitude modulating element 312.

The schematic depiction in FIG. 3 is to aid understanding and the spacing between elements is not necessarily required. For example, the coherent illumination source 310, amplitude modulating element 312, phase modulating element 314 and optical system 316 may have substantially no space between them. It will also be appreciated that the phase modulating element and amplitude modulating element may be arranged in any order in the optical path.

FIG. 3 depicts a linear arrangement of the holographic display but other arrangements may include image folding components. For example, to allow the use of an SLM comprising a micro-mirror array or other type of reflective SLM, as a phase modulating element, a folded optical path may be provided.

In examples where the screen is large compared to the expected viewing area then each group of imaging elements may have a fixed additional phase gradient to direct the emission cone of a group of imaging elements towards the nominal viewing area. The phase gradient can be provided by including an additional wedge profile on each microlens in the optical system 316, similar to a Fresnel lens, or by including a spherical term, also referred to as a spherical phase profile, on the coherent illumination source 310 that verges light to the nominal viewing position. A spherical term imparts a phase delay which is proportional to the square of the radius from the centre of the screen, the same type of phase profile provided by a spherical lens. For displays where the expected viewing area is large compared to the screen size the emission cone of each group of imaging elements may be sufficiently large that an element imparting an additional phase gradient is not required.

Some examples may include an additional non-coherent illumination source, such as a Light Emitting Diode (LED) which can be operated as a conventional screen in conjunction with the amplitude modulating element. In such examples, the display may function as both a conventional, non-holographic display and a holographic display.

Another example display construction is depicted in FIG. 4. This is the same as the construction of FIG. 3, without an amplitude modulating element. The construction comprises: a coherent illumination source 410, a phase modulating element 414 and an optical system 416 with the same construction of those elements as discussed for FIG. 3. The display of FIG. 4 may be simpler to construct than a display with an amplitude modulating element because there is no need to align and stack two layers of modulating elements. Each group of imaging elements in this example consists of four imaging elements that can be modulated in phase, so that the required four degrees of freedom to support two viewing positions is achieved.

In use, the display of FIG. 3 or FIG. 4 may be provided with the modulation values of the coherent illumination source 310, amplitude modulating element 312 and phase modulating element 314 to achieve a desired holographic image. For example, the values may be calculated to achieve a desired output image for particular pupil plane positions.

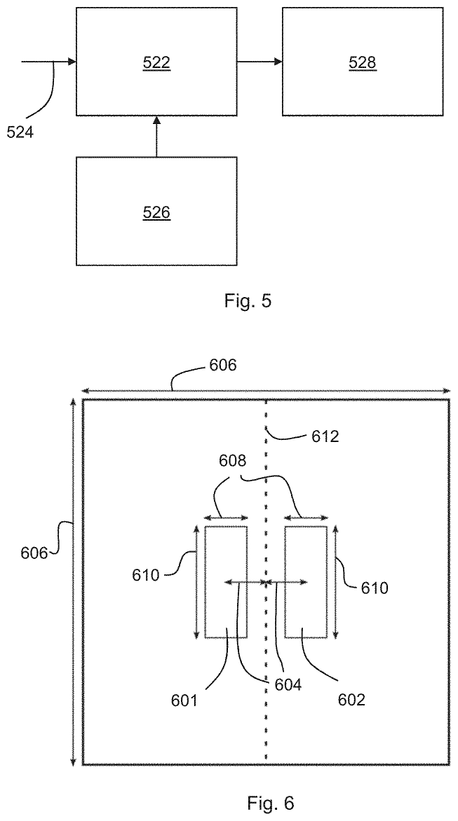

The display of FIGS. 3 and 4 may also form part of an apparatus comprising a processor which receives 3-dimensional data for display and determines how to drive the display for the viewing position. FIG. 5 depicts a schematic diagram of such an apparatus. The display system comprises a processing system 522 having an input 524 for receiving three dimensional image data, encoding colour and depth information. An eye-tracking system 526, which can track a viewer's eye position, provides eye position data to the processor 522. Eye tracking systems are commercially available or can be implemented using a programming library such as OpenCV (Open Source Computer Vision Library) in conjunction with a camera system. 3-Dimensional eye position data can be provided by using at least two cameras, structured light, and/or predetermined data of a viewer's IPD. A display system 528 receives information from the processor to display a holographic image.

In use, the processing system 522 receives input image data via the input 524 and eye position data from the eye tracking system 526. Using the input image data and the eye position data, the processing system calculates the required modulation of the phase modulation element (and the amplitude modulation element, if present) to create an image field representing the image at the determined pupil planes positioned at the viewer's eyes.

Operation of the display to provide different phase and amplitudes to two different viewing positions will now be described. For clarity, the case of a 2×1 group of sub-elements, where each sub-element can be modulated in amplitude and phase will be described. This provides four degrees of freedom (two phase and two amplitude variables) to enable the group of sub-elements to be viewed with a first phase and amplitude from a first position and a second phase and amplitude from a second position.

As explained above with reference to FIG. 2, the optical system reimages the modulated signal from an illumination source so that groups of sub-elements are reduced in size but retain the same spacing from each other. This re-imaged geometry for a display element with 2×1 group of sub-elements is depicted in FIG. 6.

Each sub-element, or emission area, 601, 602 has an associated complex amplitude U₁ and U₂. The amplitude and phase of each is controlled to produce a point a display element which appears as a point source with a first phase and amplitude when viewed from a first position of a pupil plane, and simultaneously as a point source with a second phase and amplitude when viewed from a second position of a pupil plane, the first and second positions of pupil plane corresponding to the determined positions of a viewer's eyes. The pitch between the reduced size sub-elements output from the optical system is 2a, measured from the centre line of the overall image, 612 to the centre of the imaging elements 601, 602. The dimension a is illustrated by arrows 604 in FIG. 6. The pitch of the display element, b is depicted by arrows 606 in FIG. 6. The dimension b is the spacing between the groups of imaging elements. In this example the display element is square, with each imaging element having rectangular dimensions width c, depicted by arrows 608 on FIG. 6, and height d, depicted by arrows 610 on FIG. 6.

Together, these dimensions a, b, c and d control the properties of the display as follows. The pitch of the emission areas, 2a (depicted by arrows 604) controls how rapidly the apparent value of the group can change with viewing position. For this example, the subtended angle between maximum and minimum possible apparent intensity is λ/4a, and so the display operates most effectively when the inter-pupillary distance (IPD) of the viewer subtends an angle of λ/4a, i.e. at a distance z=IPD.4a/λ. The efficiency with which content can be displayed reduces away from this position. At 0.5z it is no longer possible to display different scenes to each eye. Thus, values of a might be different for a relatively close display, such as might be used in a headset, than for a display intended to be viewed further away, such as might be useful for a portable computing device.

The pitch of the group, b (depicted by arrows 606), determines the angular size of the pupil, the angular size of the pupil being given by k/b. Thus a lower value of b increases pupil size, but requires a greater number of display elements to achieve the same field of view.

The dimensions of the emission areas, c and d (depicted by arrows 608 and 610, respectively), determine the emission cone of the group of pixels, with nulls at angles θₓ=λ/c and θ_{y}=λ/d. Image quality reduces as these nulls are approached, so maintaining acceptable image quality requires operating in a reduced area, maintaining sufficient distance from the nulls that image quality remains acceptable. Reducing c and d, so that the group of pixels is further reduced in size increases the emission cone angle of the group, but at the cost of reduced optical efficiency.

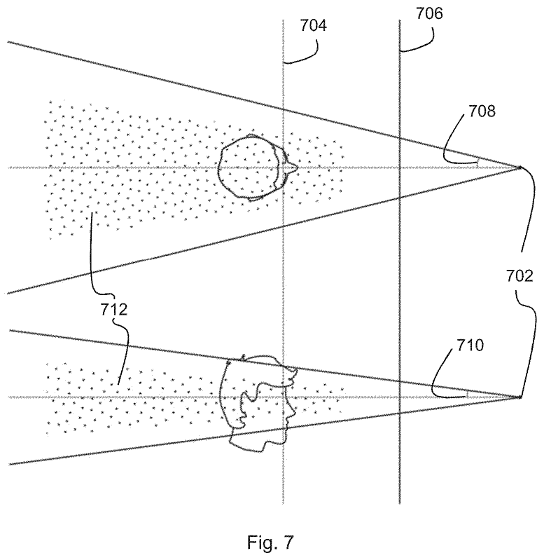

The interaction of these constraints on the viewable image is depicted in FIG. 7. The display having the group of pixels is at location 702. From the pitch between reduced emission areas, 2a, for most effective operation a viewer is located at a distance from location 702 of z=IPD.4a/λ, which is illustrated by line 704 (shown as a straight line from the plane of the screen containing location 702). As the viewer approaches the screen, it is no longer possible to supply a different amplitude and phase to each eye at a distance of z=IPD.2a/λ, which is illustrated by line 706. The horizontal viewing angle, θₓ=λ/c is depicted by angle 708. The vertical viewing angle, θy=λ/d is depicted by angle 710. Together line 706 and the cone formed from the viewing angles 708, 710 define the area where two different pupil images can be formed for a viewer. In practice, the image quality reduces close to these boundaries, so the region of acceptable image quality is smaller, as shown by dotted regions 712.

From this discussion, the benefit of the mask 320, included in some examples, can also be understood. The distance between sub-element centres is determined by the IPD and viewing distance, z, from the equations IPD/z=θ_IPD=λ/4a. Without a mask 320, c=2a, so θₓ=2×θ_IPD, giving an addressable viewing width which is 2×IPD. To make the addressable viewing width wider, it is necessary to have c<2a, which can be provided by using a mask 320 to further reduce the size of the sub-elements.

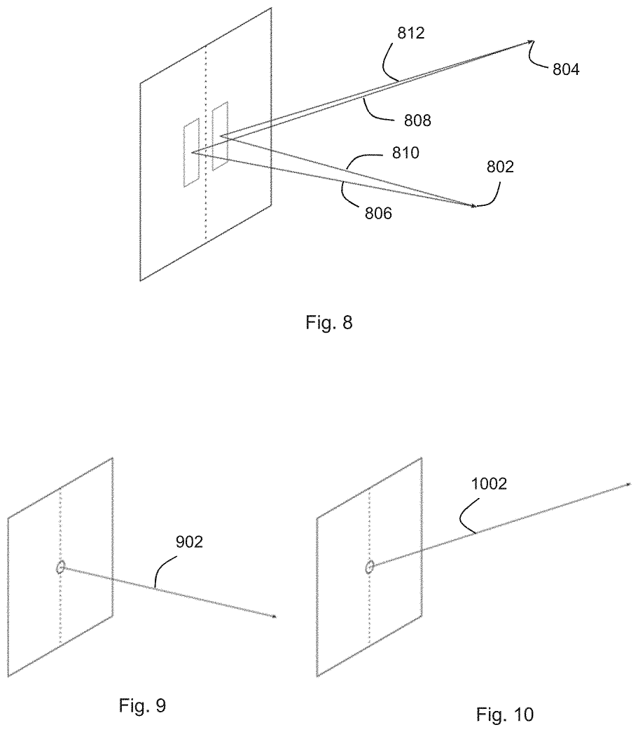

In use, the group of sub-elements is controlled according to the principles depicted in FIGS. 8, 9 and 10. There are two target locations, p₁, marked as point 802 and p₂, marked as point 804. Positions of p₁ and p₂ are predetermined or determined from the input of an eye locating system. The display element is required to appear as equivalent to a point source of complex amplitude V₁ as seen from p₁ and of complex amplitude V₂ as seen from p₂. For each imaging element within the display element the vector from the centre of the imaging element to the target location is s₁₁, s₁₂, s₂₁ and s₂₂, respectively, marked as 806, 808, 810 and 812 in FIG. 8. A complex amplitude at p₁ and p₂ is calculated as a function of U₁, U₂, s₁₁, s₁₂, s₂₁ and s₂₂. Additionally a complex amplitude due to a point source of complex amplitude V1 positioned at vector displacement r₁=(s₁₁+s₂₁)/2 from p₁ (shown as 902 in FIG. 9) is calculated, and also the complex amplitude due to a point source of target complex amplitude V₂ positioned at vector displacement r₂=(s₁₂+s₂₂)/2 from p₂ (shown as 1002 in FIG. 10) is calculated. Values of U₁ and U₂ which provide equal complex amplitudes to the target complex amplitudes at p₁ due to V₁ and at p₂ due to V₂ are then found.

Solutions to these equations may be calculated analytically, by considering Maxwell's equations which are linear (electric fields are superposable) together with known models of how light propagates from an imaging element of the aperture of the imaging elements, such as Fraunhofer or Fresnel diffraction equations. In other examples, the equations may be solved numerically, for example using iterative methods.

While this example has discussed the control of amplitude and phase of a 2×1 group of sub-elements, the required four degrees of freedom can also be provided by a 2×2 group of sub-elements which are modulated by phase only.

While this example has discussed control in which amplitude and phase are independent (in other words, there are two degrees of freedom for each sub-element), other examples may control phase and amplitude with one degree of freedom, without necessarily holding either phase or amplitude constant. For example, the phase and amplitude may plot a line in the Argand diagram of possible values of U₁ and U₂, with the one degree of freedom defining the position on that line. In that case, the required four degrees of freedom may be provided by a 2×2 group of sub-elements.

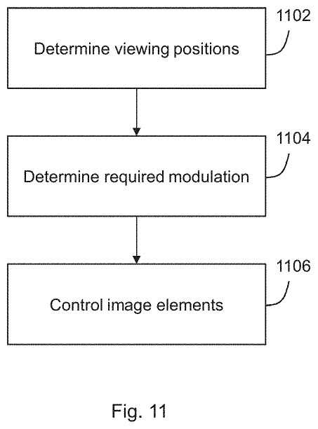

An overall method of controlling the display is depicted in FIG. 11. At block 1102, positions of viewing planes are determined. For example, the positions may be determined based on input from an eye-locating system. Next, at block 1104, a required modulation of phase, and possibly also amplitude, to generate an image field at determined positions is calculated such that the output of sub-elements within each display element combines to produce a respective first amplitude and a first phase at a first viewing position and a respective second amplitude and a second phase at a second viewing position. At block 1106, a phase, and possibly also an amplitude, of the sub-elements is controlled to produce the output.

In some examples, blocks 1102 and 1104 may be carried out by a processor of the display. In other examples, blocks 1102 and 1104 may be carried out elsewhere, for example by a processing system of an attached computing system.

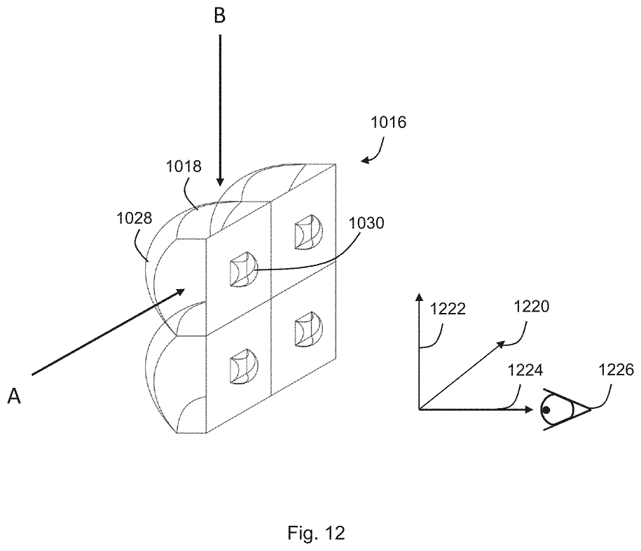

FIG. 12 depicts an optical system 1016 (such as the optical system 316, 416 of FIGS. 3 and 4). As previously described, the optical system 1016 comprises an array of optical elements 1018. Each optical element has a first lens surface 1028 and a second lens surface 1030 spaced apart from the first lens surface 1028 in a direction along an optical axis of the optical element. In use, light from at least two sub-elements passes through the first lens surface 1028, passes through the optical element 1018 along an optical path based on a wavelength of the light and passes through the second lens surface 1230 towards an eye 1026 of an observer. The example depicted shows four optical elements, but there may be a different number in other examples.

FIG. 12 also shows a first axis 1220 (such as an x-axis) extending along a first dimension, a second axis 1222 (such as a y-axis) extending along a second dimension and a third axis 1224 (such as a z-axis) extending along a third dimension. The first axis 1220 is generally arranged horizontally, the third axis 1224 faces towards an observer, and may be parallel to a pupillary axis defined by the eye 1226 of the observer, and the second axis 1222 is orthogonal/perpendicular to both the first and third axes 1220, 1224. In some cases, the second axis 1222 is arranged substantially vertically, but may sometimes be angled/tilted with respect to the vertical (for example, if the display forms part of a computing device, the display may be angled upwards, and an observer may be looking downwards, towards the display. The second and third axes 1222, 1224 may therefore be rotated about the first axis 1220, in certain examples.

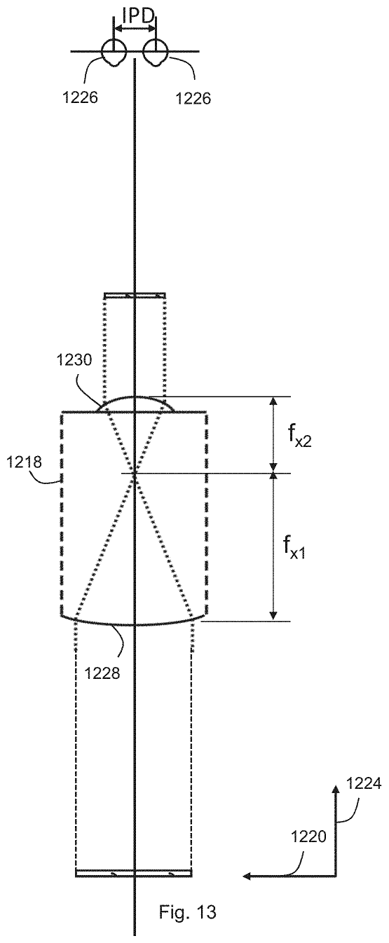

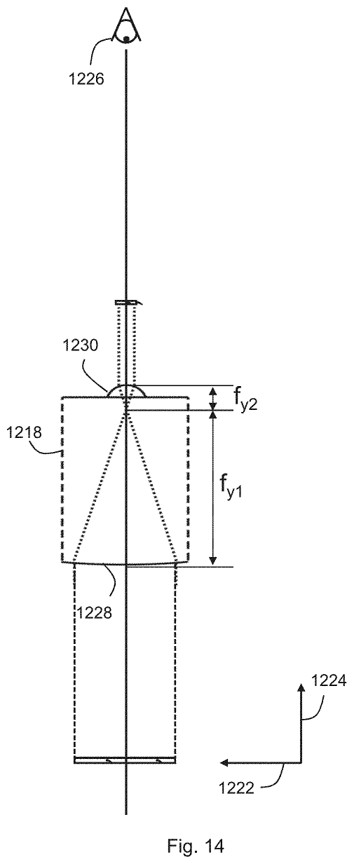

With reference to the overall geometry of FIG. 12, FIGS. 13 and 14 depict respective cross-sections through an optical element 1218 which has a different magnification in different directions. FIG. 13 depicts a cross section through an optical element 1218 in a first plane defined by the first and third axes 1220, 1224 and viewed along arrow B. The second axis 1222 therefore extends out of the page.

As shown, the first lens surface 1228 has a first curvature (defined by a first radius of curvature) in this first plane and the second lens surface 1230 has a second curvature (defined by a second radius of curvature) in the first plane. In this example, the first and second curvatures are different, which results in different focal lengths for each lens surface. The first lens surface 1228 has a first focal length fₓ₁ in the first plane and the second lens surface 1230 has a second focal length fₓ₂ in the first plane.

The magnification, M₁, along the first axis/dimension 1220 (referred to as a “first magnification”) is given by the ratio of the first focal length to the second focal length, so M₁=fₓ₁/fₓ₂. Controlling the first radius of curvature, the second radius of curvature and therefore the first and second focal lengths in the first plane therefore controls the magnification in the first dimension.

FIG. 14 depicts a cross section through the optical element 1218 in a second plane defined by the second and third axes 1222, 1224 and viewed along arrow A. The first axis 1220 therefore extends into the page. As shown, the first lens surface 1228 has a third curvature (defined by a third radius of curvature) in this second plane and the second lens surface 1230 has a fourth curvature (defined by a fourth radius of curvature) in the second plane. The curvature of each lens surface is therefore different in each plane. In this example, the third and fourth curvatures are different, which results in different focal lengths for each lens surface. The first lens surface 1228 has a third focal length f_{y1} in the second plane and the second lens surface 1230 has a fourth focal length f_{y2} in the second plane.

The magnification, M₂, along the second axis/dimension 1222 (referred to as a “second magnification”) is given by the ratio of the third focal length to the fourth focal length, so M₂=f_{y1}/f_{y2}. Controlling the third radius of curvature, the fourth radius of curvature and therefore the third and fourth focal lengths in the second plane therefore controls the magnification in the second dimension.

Generally, the magnification in the first dimension is constrained based on the angle subtended between the pupils of an observer, and therefore the inter-pupillary distance (IPD), as shown in FIG. 13. The first magnification therefore controls the horizontal viewing angle depicted by angle 708 in FIG. 7.

In contrast, the magnification along the second axis/dimension 1222 is not constrained by the inter-pupillary distance (IPD), so may be different to the magnification along the first axis 1220. Accordingly, the magnification along the second axis 1222 can be increased to provide an increased range of viewing positions along the second axis 1222. The second magnification therefore controls the vertical viewing angle depicted by angle 710 in FIG. 7. The increased magnification therefore increases the vertical viewing angle 710.

The following discussion sets example limits on the first and second magnifications. As discussed above, the following derivation assumes that the eyes of an observer are horizontal along the first axis 1220 (x-axis).

It is desirable for the separation of the centres (measured along the first axis) of the reimaged sub-pixels to be such that it is possible for light from the two subpixels to interfere predominantly constructively at one eye and destructively at the other eye.

Accordingly, x_{reimaged}=x_{subpixel}/M₁, where x_{subpixel} is the distance between subpixel centres along the first axis 1220 (and corresponds to 2*a from FIG. 6).

This sets the condition that:

x_{reimaged}˜viewing distance*wavelength/(2*IPD). [1]

Where the viewing distance is the distance to the observer measured along the third axis 1224, and wavelength is the wavelength of the light.

It will be appreciated that this condition does not need to be exactly met, so x_{reimaged} may be approximately 75%-150% of this ideal value, and still generate an image of acceptable quality. This means the system can be designed based on nominal/typical values of IPD and viewing distance.

In addition, there is a further condition that the separation between groups of subpixels, xₚᵢₓₑₗ, from adjacent display elements, is set by the required “eyebox” size along the first axis 1220 (i.e. its width). The “eyebox” is the region in the pupil plane (normal to the pupillary axis) in which the pupil should be contained within for the user to view an acceptable image. This condition requires that:

xₚᵢₓₑₗ=viewing distance*wavelength/eyebox_width. [2]

Combining equations [1] and [2] gives:

x_{reimaged}˜xₚᵢₓₑₗ*eyebox_width/(2*IPD).

Which means that:

M₁˜2*IPD*x_{subpixel}/(xₚᵢₓₑₗ*eyebox_width).

Typically, x_{subpixel}=xₚᵢₓₑₗ/2, so M₁˜IPD/eyebox_width. IPD is typically 60 mm, and a required eyebox size may be in the range 4-20 mm, so M₁ is likely to be in the range 3-15.

In the second dimension 1222 (y-axis), it is typical that yₚᵢₓₑₗ=xₚᵢₓₑₗ (i.e. it is desirable to have an eyebox that has a 1:1 aspect ratio). Also, the height of the sub-pixel is typically a large fraction of yₚᵢₓₑₗ. The two central nulls of the emission cone from a group of subpixels in the second dimension 1222 are separated at the viewer by a distance of:

y_{distance}=M₂*viewing_distance*wavelength/subpixel_height˜M₂*viewing_distance*wavelength/xₚᵢₓₑₗ˜M₂*eyebox_width˜M₂*IPD/M₁.

The ‘addressable viewing area’ may be taken to be approximately half this height, i.e. M₂*IPD/(2*M₁). If M₁=M₂ then the height of the addressable viewing area is ˜30 mm, which is too small to be easily usable. As discussed above, it is preferable to have M₂>M₁, because there are not the same constraints on M₂ as on M₁.

The practical upper limit for how large M₂ can be set is determined by the size of the pixels. It was assumed that y_{reimaged}=y_{subpixel}/M₂, but in practice the system is diffraction limited, and y_{reimaged} cannot be smaller than the numerical aperture (NA) of the system multiplied by the wavelength of the light. A typical NA is <0.5 and wavelength ˜0.5 μm, so y_{reimaged}>1 μm. For a typical system (M₁=6, implying a 10 mm eyebox, 600 mm viewing distance), y_{subpixel}=30 μm, so in this case M₂⇐30, M₂/M₁⇐5.

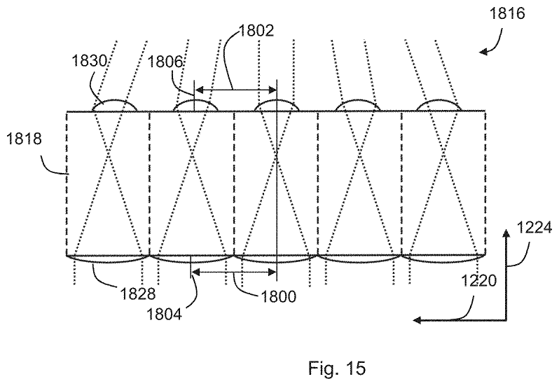

FIG. 15 depicts another example optical system 1816 in which the optical system is configured to direct an image towards a viewer or more generally to converge on a viewing position. Again reference is made to the directions defined with reference to FIG. 12. Optical system 1816 is shown in cross section in a first plane defined by the first dimension/axis 1220 and the third dimension/axis 1224. The optical system 1816 could be used in place of optical systems 316, 416 depicted in FIGS. 3 and 4 in some examples. The properties of the optical system 1816 described herein could also be incorporated into the optical system 1218 of FIGS. 13 and 14. In this example, the optical system 1816 comprises an array of optical elements 1818. Each optical element has a first lens surface 1828 and a second lens surface 1830 spaced apart from the first lens surface 1228 in a direction along an optical axis of the optical element. Together, the first lens surfaces of the individual optical elements 1818 may form a first lens surface of the optical system 1816. Similarly, the second lens surfaces of the individual optical elements 1818 may form a second lens surface of the optical system 1816. The example depicted shows 5 optical elements 1818 extending along the first axis 1220, but there may be a different number in other examples.

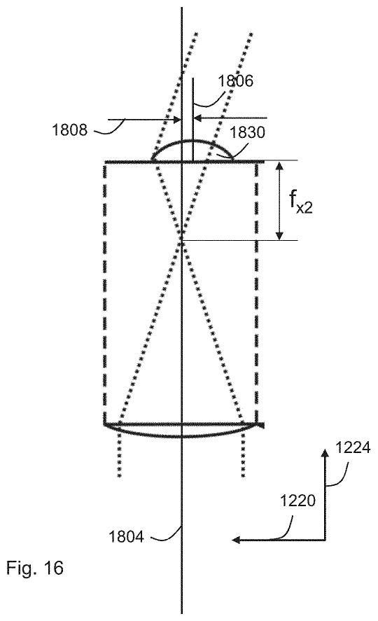

The optical system 1816 of FIG. 15 is designed to converge light towards a viewing position/location. The first lens surface 1828 of each optical element 1818 has a first optical axis 1804 and the second lens surface 1828 has a second optical axis 1806. To achieve the convergence in the horizontal dimension, the first optical axis 1804 is offset from the second optical axis by a distance 1808 (shown in FIG. 16) measured perpendicular to the first and second optical axes 1804, 1804 (i.e. measured along the first dimension 1220). FIG. 16 shows a close up of one optical element 1818 to more clearly show the offset. In some examples, the offset is also present along the second dimension 1222 to achieve convergence in the vertical orientation.

This offset means that a first pitch 1800 (p₁) between adjacent first lens surfaces 1828 (of adjacent optical elements 1818) is larger than a second pitch 1802 (p₂) between adjacent second lens surfaces 1830 (of adjacent optical elements 1818). Thus adjacent second lens surfaces 1830 are closer together than corresponding adjacent first lens surfaces. In an example, the ratio of the first pitch to the second pitch is between about 1.000001 and about 1.001, put another way, the first pitch is different from the second pitch by between 1 part in 1000 and 1 part in 1,000,000. In another example the ratio of the first pitch to the second pitch is between about 1.00001 and about 1.0001, put another way, the first pitch is different from the second pitch by between 1 part in 10,000 and 1 part in 100,000. In some examples, the second pitch 1802 depends on the focal length of the second lens surface 1830.

For optical elements 1818 towards the outer edges of the optical system/display, the offset may be greater than for optical elements 1818 towards the center of the optical system for display to ensure that the convergence is greater towards the edge than at the center. Accordingly, the offset may be based on the distance of the optical element from the center of the display and may be based on the size (width and/or height) of the optical system 1816.

In an example, the offset 1806 (x_{offset}) measured along the first axis 1200 is given by x_{offset}=x*f₂ₓ/viewing distance, where the viewing distance is the distance to the viewer measured along the along the third axis 1224 and f₂ₓ is the focal length of the second lens surface in the first plane.

The distance to the center of the nth optical element from the center of the central optical element of the array is x, and x=n*p₁, then p2=(x−x_{offset})/n=p1*(1−(f₂ₓ/viewing_distance)).

Typically, f₂ₓ may be of order 100 μm, and the viewing distance is of order 600 mm, so the difference in pitch may be smaller than 1 part in 1000. As the total number of lenses may be >1000 however, x_{offset} at the edge of the screen may be a significant fraction of the optical element's width.

Although this analysis is shown for first dimension 1220, the same principles can be applied for the second dimension 1222. As outlined above, M₂ may be bigger than M₁, meaning that the fractional difference in pitch may be smaller in the first dimension than in the second dimension.

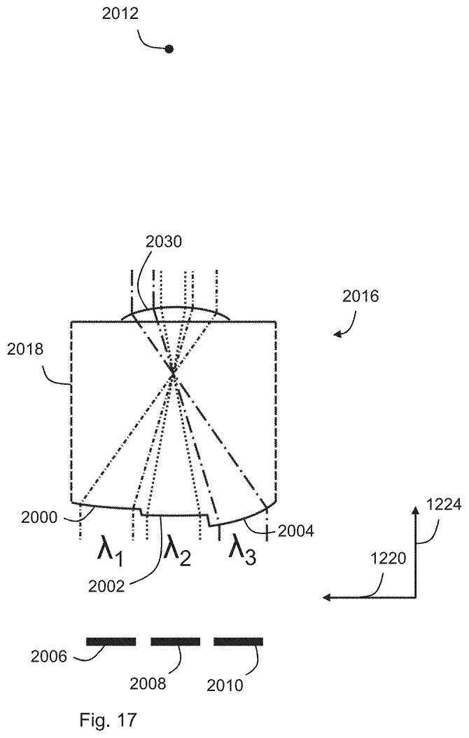

FIG. 17 depicts an example optical element 2018 of an array of optical elements 2018 forming an example optical system 2016 which is for colour holographic displays where different colours are emitted simultaneously but spaced apart (in contrast with displays that produce colour by time multiplexing the different colours). Once again, the dimensions are discussed with reference to the definitions in FIG. 12, The optical element 2018 is shown in cross section in a first plane defined by the first dimension/axis 1220 and the third dimension/axis 1224. The optical element 2018 could form part of the optical systems 316, 416 depicted in FIGS. 3 and 4 in some examples. The properties of the optical system 2016 described herein could also be incorporated into the optical systems 1218, 1818 of FIGS. 12 and 18.

Each optical element 2018 has a first lens surface and a second lens surface 2030 spaced apart from the first lens surface in a direction along an optical axis of the optical element. The first lens surface of this example comprises two or more surface portions each optically adapted for a different specific wavelength. In this example, the first lens surface comprises a first surface portion 2000 optically adapted for light having a first wavelength λ₁, a second surface portion 2002 optically adapted for light having a second wavelength λ₂ and a third surface portion 2004 optically adapted for light having a third wavelength λ₃. In this particular example, the light having the first wavelength is emitted by a first emitter 2006, the light having the second wavelength is emitted by a second emitter 2008, and the light having the third wavelength is emitted by a third emitter 2010. Accordingly, because of the spatial relationship between the emitters and the optical element 2018, the light of each wavelength is incident upon a particular portion of the first lens surface. Thus, the light incident upon each surface portion is predominantly light of a particular wavelength. To compensate for the wavelength dependent effects of the optical element 1818 (such as a wavelength dependent refractive index), the surface portions can be adapted for each wavelength so that the light can be converged towards a particular point 2012 in space close the observer's eyes. As explained in more detail below, these wavelength dependent effects may be more prevalent for highly dispersive materials, such as a material having a high refractive index. High refractive index materials may be needed when the optical system 1816 is bonded to a screen with an optically clear adhesive.

In this example, the surface portions can be optically adapted by having a surface curvature suitable for the dominant wavelength of light incident upon the surface portion. For example, the first surface portion 2000 is optically adapted for the first wavelength by having a first radius of curvature, the second surface portion 2002 is optically adapted for the second wavelength by having a second radius of curvature and the third surface portion is optically adapted for the third wavelength by having a third radius of curvature, where the first, second and third surface curvatures are different. The surface curvatures can be defined by a radius of curvature, for example.

As described above, a focal length in a particular plane is based on the surface curvature in that plane. Accordingly, the first lens surface (or the first surface portion 2002) has a first focal point for light having the first wavelength and the second lens surface 2030 has a second focal point for light having the first wavelength. In some examples, the first and second focal points for the light having the first wavelength are coincident. This may improve the overall image quality, by improving focus, for example. Similarly, the first lens surface (or the second surface portion 2004) has a first focal point for light having the second wavelength and the second lens surface 2030 has a second focal point for light having the second wavelength and the first and second focal points for the light having the second wavelength are coincident. Similarly, the first lens surface (or the third surface portion 2006) has a first focal point for light having the third wavelength and the second lens surface 2030 has a second focal point for light having the third wavelength and the first and second focal points for the light having the third wavelength are coincident.

In an example, each surface portion may have a spherical or toroidal profile, with a first radius of curvature rₓ in a first plane and a second radius of curvature r_{y} in a second plane. If the surface portion has a spherical profile, then rₓ=r_{y}. A surface with such a profile causes rays to come to a focus at a distance r/(nₗₑₙₛ−n_{incident}), where nₗₑₙₛ is the refractive index of the lens material and n_{incident} is the refractive index of the surrounding material (such as air or an optically clear adhesive). For air, n_{incident}=1. As mentioned because n varies as a function of wavelength, there is a focal length shift for light of different wavelengths. This can be compensated by having a different radius of curvature in different regions of the lens to compensate for the change in refractive index. i.e. rₓ(wavelength)=f₁ₓ*(nₗₑₙₛ(wavelength)−n_{incident}(wavelength)), where f1x is the focal length of the surface portion in the first plane and rₓ and n are both functions of wavelength. A similar equation exists for r_{y}(wavelength)=f_{1y}*(nₗₑₙₛ(wavelength)−n_{incident}(wavelength)).

As mentioned, this is particularly important if the array is mounted using optically clear adhesive (n_{incident}˜1.5) because nₗₑₙₛ must then be higher (typically ˜1.7), and higher index materials are typically more dispersive (i.e. the refractive index will change more rapidly with wavelength). For example, the material N-SF15 has n(635 nm)=1.694 and n(450 nm)=1.725, meaning the difference in the radii of curvatures for the red and blue surface portions (i.e. the first and third surface portions) is over 4%.

As mentioned, an optically clear adhesive may be used to mount the optical systems described above onto a display panel. This can make it easier to manufacture the holographic display while also improving the display's physical robustness. To compensate for the adhesive, the optical system must be made of a material with a greater refractive index compared to the adhesive. For example, the refractive index of the material in the optical system (such as the material of the optical elements) is typically about 1.7 whereas the refractive index of the adhesive is about 1.5 to achieve the required refraction at the boundary. Because the high index material of the optical system is likely to have a higher dispersion, the optically clear adhesive may be used in conjunction with the optical system of FIG. 17, as mentioned above.

Example acrylic based optically clear adhesive tapes are manufactured by Tesa™, such as Tesa™ 69401 and Tesa™ 69402. Example liquid optically clear adhesives are manufactured by Henkel™, and a particularly useful adhesive is Loctite™ 5192 which has a relatively low refractive index (less than 1.5) of about 1.41, making it particularly well suited for this purpose.

The above embodiments are to be understood as illustrative examples of the invention. Further embodiments of the invention are envisaged. For example, while the description above has considered a single colour of light, the examples can be applied to systems with multiple colours, such as those in which red, green and blue light is time division multiplexed. In addition, although two viewing positions have been discussed (allowing binocular viewing), other examples may provide more than two viewing positions by increasing the number of degrees of freedom in each display element, such as by increasing a number of sub-elements in each display element. A system with n degrees of freedom, where n is a multiple of 4, can support n/2 viewing positions and hence binocular viewing by n viewers. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A holographic display comprising:
an illumination source which is at least partially coherent;
a plurality of display elements positioned to receive light from the illumination source and spaced apart from each other, each display element comprising a group of at least two sub-elements; and
a modulation system associated with each display element and configured to modulate at least a phase of each of the plurality of sub-elements.

2. A holographic display according to claim 1, further comprising an optical system configured to generate the plurality of display elements by reducing the size of the group of sub-elements within each display element such that the group of sub-elements are spaced closer to each other than they are to sub-elements of an immediately adjacent display element.

3. A holographic display according to claim 2, wherein the optical system comprises an array of optical elements.

4. A holographic display according to claim 2, wherein the optical system has different magnifications in first and second dimensions, and a first magnification in the first dimension is less than a second magnification in second dimension.

5. A holographic display according to claim 4, wherein the first dimension is substantially horizontal in use, and wherein the second dimension is perpendicular to the first dimension.

6. A holographic display according to claim 4, wherein the optical system comprises an array of optical elements, each optical element comprising first and second lens surfaces, at least one of the first and second lens surfaces having a different radius of curvature in a first plane, defined by the first dimension and a third dimension, than in the second plane, defined by the second dimension and the third dimension

7. A holographic display according to claim 6, wherein:
the first and second lens surfaces are associated with first and second focal lengths respectively in the first plane, and the first magnification is defined by the ratio of first and second focal lengths; and
the first and second lens surfaces are associated with third and fourth focal lengths respectively in the second plane, and the second magnification is defined by the ratio of third and fourth focal lengths.

8. A holographic display according to claim 2, wherein the optical system comprises an array of optical elements each comprising:
a first lens surface configured to receive light having a first wavelength and light having a second wavelength, different from the first wavelength; and
a second lens surface in an optical path with the first lens surface;
wherein the first lens surface comprises a first surface portion optically adapted for the first wavelength and a second surface portion optically adapted for the second wavelength.

9. A holographic display according to claim 8, wherein the first surface portion is optically adapted for the first wavelength by having a first radius of curvature and the second surface portion is optically adapted for the second wavelength by having a second radius of curvature.

10. A holographic display according to claim 8, wherein the first lens surface has a first focal point for light having the first wavelength and the second lens surface has a second focal point for light having the first wavelength and the first and second focal points are coincident.

11. A holographic display according to claim 2, wherein:
the optical system is configured to converge light passing through the optical system towards a viewing position;
the optical system comprises an array of optical elements, each optical element comprising a first lens surface with a first optical axis and a second lens surface with a second optical axis; and
the first optical axis is offset from the second optical axis.

12. A holographic display according to claim 11, wherein an optical element positioned closer to an edge of the display has an offset that is greater than an offset for an optical element positioned closer to a center of the display.

13. A holographic display according to claim 12, wherein each optical element comprises a first lens surface and a second lens surface spaced apart from the first lens surface along an optical path through the optical element, and wherein the first lens surfaces are spaced apart along the array at a first pitch and the second lens surfaces are spaced along the array at a second pitch, the second pitch being smaller than the first pitch.

14. A holographic display according to claim 1, wherein each display element consists of a two-dimensional group of sub-elements having dimensions n by m, where n and m are integers, and wherein one of:
n is equal to 2, m is equal to 1 and the modulation system is configured to modulate a phase and an amplitude of each sub-element; and
n is equal to 2, m is equal to 2 and the modulation system is configured to modulate a phase of each sub-element.

15. A holographic display according to claim 1, comprising a convergence system arranged to direct an output of the holographic display towards a viewing position.

16. A holographic display according to claim 1, comprising a mask configured to limit a size of the sub-elements.

17. An apparatus comprising:
a holographic display according to any preceding claim; and
a controller for controlling the modulation system such that each display element has a first amplitude and phase when viewed from a first position and a second amplitude and phase when viewed from a second position.

18. An apparatus according to claim 17, further comprising an eye-locating system configured to determine the first position and the second position.

19. A method of displaying a computer-generated hologram, the method comprising:
controlling a phase of a plurality of groups of sub-elements such that the output of sub-elements within each group combines to produce a respective first amplitude and a first phase at a first viewing position and a respective second amplitude and a second phase at a second viewing position.

20. A method according to claim 19, further comprising:
determining the first viewing position and the second viewing position based on input received from an eye-locating system.
